(19) United States
(12) Patent Application Publication
(10) Pub. No.: US 2002/0194498 A1
(43) Pub. Date: Dec. 19, 2002

(54) Mobile communication system for location aware services

(75) Inventors: David Blight, Santa Clara, CA (US); Elaine Lusher, Pleasanton, CA (US); Stuart Eichert, Mountain View, CA (US)

Correspondence Address: Alistair K. Chan, FOLEY & LARDNER, Firstar Center, 777 East Wisconsin Avenue, Milwaukee, WI, 53202-5367, US

(73) Assignee: Palm, Inc.

(21) Appl. No.: 09/870,149

(22) Filed: May 30, 2001

(51) Int. Cl. G06F 15/173

(52) U.S. Cl. 713/201

(57) ABSTRACT

A communications network infrastructure is disclosed. The infrastructure is configured to more effectively service mobile devices having wireless communications links to the communications network.

### BACKGROUND

Handheld computing devices, “palmtops,” “palmhelds,” personal digital assistants (PDAs), or handheld computers typically weigh less than a pound and fit in a pocket. These handhelds generally provide some combination of personal information management, database functions, word processing, and spreadsheets as well as voice memo recording, wireless e-mail, and wireless telephony functions.

Handheld computers may include hardware modules which allow a user to access and communicate wirelessly with both wired and wireless communications networks. Such networks may include Local Area Networks (LANs) and Personal Area Networks (PANs).

Technologies such as Bluetooth and IEEE 802.11 provide a means to connect mobile devices to a communications network, however they do not specifically address many problems that need to be solved to provide a preferred user experience. Some of the current challenges not currently addressed are:

Conventional systems may not enable quick connection establishment to access points. Low power wireless solutions such as Bluetooth have a limited range of coverage. A mobile user may move through a coverage area quickly, and may not tolerate slow connection establishment, or service discovery.

Conventional systems may not enable the use of multiple networks in a small area. Wireless technology such as Bluetooth is being deployed for more than just network access. Potentially a large number of small range networks will exist for personal use (Personal Area Networks or PANs). Accordingly, mobile devices may want to use resources simultaneously from multiple networks.

Conventionally, when a mobile device connects to a network, it needs to be able to locate the available resources. Accordingly, a service discovery mechanism consistent with mobile devices is therefore highly desired.

Classes of security in which different mobile devices can authenticate themselves for access to different resources are not offered by systems presently.

Conventional systems may preclude the use of IP based applications. Accordingly, a desired system may provide an alternative, but many applications will expect an IP based network .

Conventional systems may not address the problems of unwanted or unsolicited information such as SPAM reaching the mobile device. A preferred system may be designed to support filtering of unsolicited communications based on user defined preferences.

Power consumption is a big concern for conventional mobile devices. A preferred system may attempt to minimize the power requirements by reducing the communications between mobile devices and the network.

Conventional systems may not be general enough to support various system should be general enough to support any type of application or communication.

Accordingly, there is a need for a system which can support communication for mobile devices (such as handheld computers) which have wireless connectivity to (through technology such as Bluetooth and/or 802.11) a communications network. Further, there is a need for a system and method for providing location aware information delivery to mobile devices, and location aware services. Further, there is a need for a Network infrastructure on which these services can be implemented.

Accordingly, it would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the above-mentioned needs.

### SUMMARY

An exemplary embodiment relates to a network infrastructure for supporting communications with mobile devices. The network infrastructure includes a communications network. The network infrastructure also includes a mobile resources server coupled to the communications network. Further, the network infrastructure includes a mobile resources proxy coupled to the communications network. Further, the network infrastructure includes a mobile device coordinator coupled to the communications network. Further, the network infrastructure includes a security server coupled to the communications network. Further still, the network infrastructure includes a mobile device access point coupled to the communications network and configured for communications with mobile devices.

Another exemplary embodiment relates to a communications system for communicating with mobile wireless devices. The communications system includes a communications network. The communications system also includes a wireless device access point coupled to the communications network, at least one mobile wireless device configured to communicate with the wireless access point when the mobile wireless device is within a communications range, and a centralized management system configured to manage and control mobile device resources.

Yet another exemplary embodiment relates to a method of providing a web page to a mobile device using a Bluetooth wireless transceiver. The method includes establishing a wireless communications link with the mobile device, receiving a web page request from the mobile device, and interpreting the request. The method also includes sending the request to a mobile resources proxy that verifies the request with a security server and after verification retrieves the web page, receiving the web page from the mobile resources proxy, and sending the web page to the mobile device.

Still yet another exemplary embodiment relates to a method of providing a web page to a mobile device using an IEEE 802.11 wireless transceiver. The method includes establishing a wireless communications link with a local area network (LAN) access point. The method also includes locating a mobile resources server, requesting a web proxy location, receiving a web proxy location, and requesting the web page through LAN access point and through mobile resource proxy. Further, the method includes receiving the web page from the mobile resources proxy.

Yet still another exemplary embodiment relates to a method of retrieving a web page by a mobile device using an IEEE 802.11 wireless transceiver. The method includes establishing a wireless communications link with a local area network (LAN) access point. The method also includes requesting a web page via a network gateway, intercepting the request by a firewall, sending the request by the firewall to a mobile resources proxy, verifying request by the mobile resources proxy using a mobile resources server, and receiving the web page through the mobile resources proxy.

Yet still another exemplary embodiment relates to a method of providing a secure document to a mobile device using a Bluetooth transceiver. The method includes establishing a wireless communications link with the mobile device, and receiving a web page request from the mobile device. The method also includes interpreting the request, sending the request to a mobile resources proxy, providing an authorization for the mobile device, and receiving authorization information from the mobile device. Further, the method includes sending the authorization information to a mobile resources server that verifies authorization information. Further still, the method includes receiving the web page from the mobile resources proxy, and sending the web page to the mobile device.

Yet still another exemplary embodiment relates to a method of providing location information to a mobile device. The method includes receiving a location request from the mobile device. The method also includes sending the request to a navigation service that requests the mobile device location from a mobile device coordinator and receives a current location from the mobile device coordinator. Further, the method includes receiving a map from the navigation service, the map being developed by the navigation service based on the current location, and sending the map to the mobile device.

Yet further still another exemplary embodiment relates to a method of providing a messaging service for a mobile device. The method includes receiving a registration message to a chat service, determining if a message is to be sent to the mobile device, locating the mobile device, and sending the message to an access point that is in communications with the mobile device, the access point sending the message to the mobile device.

Alternative exemplary embodiments relate to other features and combination of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an exemplary front elevation view of a handheld computer;

FIG. 2 is an exemplary schematic diagram of a communications network infrastructure; and

FIG. 3 is an exemplary schematic diagram of a wireless access proxy.

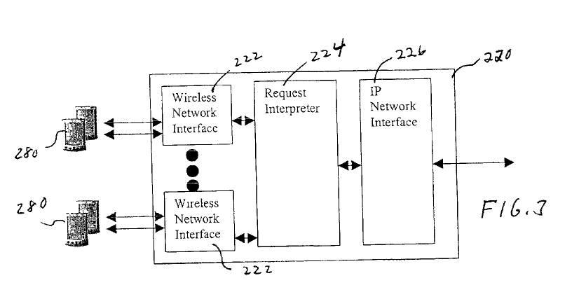

### DETAILED DESCRIPTION OF EXEMPLARY EMBODIMENTS

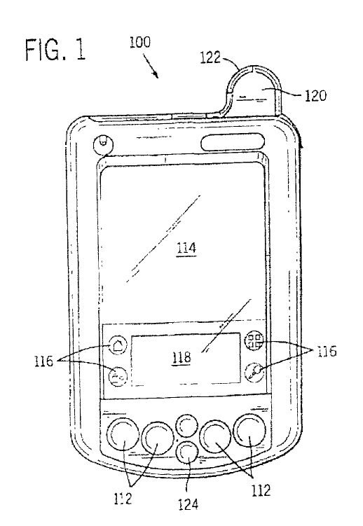

Referring to FIG. 1, a handheld computer 100 is depicted according to an exemplary embodiment. Handheld computer 100 may include Palm style computers manufactured by Palm, Inc., of Santa Clara, Calif. Other exemplary embodiments may include Windows CE handheld computers, or other handheld computers and personal digital assistants, as well as mobile telephones, pagers, and other mobile computing devices.

Preferably, handheld computer 100 includes interactive hardware and software that performs functions such as maintaining calendars, phone lists, task lists, note pads, calculator applications, spreadsheets, games, video files, and other applications capable of running on a computing device. Further, handheld computer 100 may be configured for such functions as voice memo recording and playback as well as communications network connectivity, Internet connectivity, wireless messaging, e-mail, always-on e-mail, and wireless telephony.

Handheld computer 100, depicted in FIG. 1, includes a plurality of input function keys 112 and a display 114 having graphical user interface features. Display 114 may be provided with a touch screen interface that allows a user to select and alter displayed content using a pointer, such as but not limited to a stylus, a pen tip, a fingertip, or other pointing devices.

Referring again to FIG. 1, in an exemplary embodiment, display 114 also includes a Graffiti™ (or other handwriting recognition software) writing section 118 for tracing alpha-numeric characters as input. A plurality of input icons 116 for performing automated or preprogrammed functions may be provided on a portion of display 114.

In an exemplary embodiment, handheld computer 100 may include an integrated antenna 120 configured to transmit and receive wireless communication signals, such as, but not limited to, cellular telephone communication signals and other radio frequency (RF) communications signals using an RF transceiver. Antenna 120 may further include an indicator light 122 integrated into antenna 120 for indicating the transmission and reception of wireless communication signals. Further, light 122 may be used to indicate other states of handheld computer 100. Further, handheld computer 100 may include a wireless transceiver, such as a Bluetooth transceiver or an IEEE 802.11 standard transceiver, or other RF or wireless transceiver, such that handheld computer 100 is configured to communicate with other nearby devices and/or access points to a communications link.

In an exemplary embodiment, handheld computer 100 also includes navigation buttons 124 that may be utilized for navigating or scrolling of information displayed on display 114. Further, navigation buttons 124 may be programmed for other uses depending on the application running on handheld computer 100. Handheld computer 100 may be used for any of a variety of wireless communications, including, but not limited to, communications with the World Wide Web, mobile telephone communications, e-mail communications, etc.

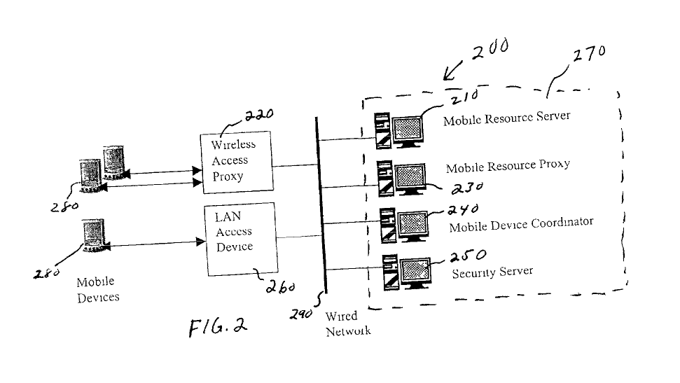

Referring now to FIG. 2, a communications system architecture 200 is depicted. System 200 is configured to provide one or more of the following functions:

1. Provide an interface between mobile wireless devices and resources on a wired network.

2. Support multiple methods of location determination including mobile device and network based location determination.

3. Provide and support multiple quick and simple discovery mechanism because it is important that the mobile resource server be quickly discovered when a mobile device is moving between access point coverage areas.

4. Provide a centralized management point for managing and controlling mobile device resources. In many environments including retail and enterprise deployments, it may be important that the resource being made available to the mobile device be managed for issues such as security, consistent look, consistent data modeling and encoding, and consistent access protocols.

5. Support distributed data servers. While the management may need to be centralized, the actual data distribution may be distributed for better performance and scalability.

6. Support content customization based upon location, time, and user preferences.

7. Support multiple wireless technologies

8. Provide security by including user/device authentication, cookies, access control and the like.

9. Support push and pull information models

10. Support exporting location information and location changes to external applications.

In an exemplary embodiment, system 200, which is a communications network and/or a network infrastructure includes a Mobile Resource Server 210, a Wireless Access Proxy (WAP) 220 (which may be optional), a Mobile Resource Proxy 230, a Mobile Device Coordinator (MDC) 240, a Security Server 250, and a local area network (LAN) access device 260.

Each of the services 210, 230, 240, and 250 are shown on a separate computer. However, the services may all be combined onto a single computer 270 or multiple computers providing all or some of the services. Mobile devices 280 may connect to a wired network such as a LAN by any of a variety of protocols and using any of a variety of wireless devices.

In order to provide a flexible and extendable system 200, a consistent addressing and message format for all communications in the system needs to be established.

According to an exemplary embodiment, a message may contain the following information:

Source: address of the message source

Destination: address of the message destination

Message Type: the type of message

Message Body: the data part of the message

Optionally the message may also contain:

Checksums: to verify message integrity

Signatures: to verify sender

Length: length of message body

Sequence number: to identify

Acknowledgement number

All addresses may be specified as high level standard addresses such as URLs. URLs may be used as they can consistently represent the address of an application or device. This format is advantageous because it is also consistent with existing Internet applications. Further, any reasonable and applicable type of encoding may be used for the messages. In an exemplary embodiment, XML may be used. An example message (XML encoded) may be formatted as:

<Message>

<Source>Bluetooth:ADAE06000084:1234</Source>

<Destination>http://www.palm.com</Destination>

</MessageType>http get</MessageType>

</MesssageBody/>

</Message>

which may correspond to an http request for www.palm.com from a mobile device with a Bluetooth address ADAE06000084. In this example, the message body is null, but may potentially contain http request information (MIME encoded, e.g.). Further, the message body may contain an encapsulated message.

In an exemplary embodiment, mobile device 280 may be any device which connects to the network via a wireless protocol (e.g. Bluetooth or 802.11). Each mobile device 280 network interface may have a unique address associated with it. Usually this is a 48 bit MAC address which is globally unique. Mobile device 280 may also have zero or more mobile IDs. The mobile IDs are used to provide an address that network based applications may send requests to mobile device 280 without needing to know its location, or current access connection (which access point it is using). A null source address may be considered the same as a MAC address. This may be used to shorten the message. If the MAC address is not specified in the message, the device being communicated to will still know the MAC address of the message (its part of the lower layer protocols). If a mobile device 280 sends a request with its MAC address as source, the mobile device is only requesting information and/or the mobile device is requesting a new mobile ID.

In an exemplary embodiment, Wireless Access Proxy (WAP) 220 acts as a bridge between mobile device 280 and the wired network using a wireless network interface 222, a request interpreter 224, and an IP network interface 226. WAP 220 uses wireless technology protocols and not the IP protocol stack. WAP 220 will be used when IP protocol support is not available on mobile device 280 because IP protocols are not efficient for reasons such as but not limited to high connection establishment times, mobility support being required, less overhead (higher throughput) with lower layer protocols, power consumption requirements, high error rates associated with wireless technology, and simplicity. In an exemplary embodiment, WAP 220 may be addressed directly by the mobile device using its Bluetooth address:

<Message>

<Source>Bluetooth:ADAE06000084:1234</Source>

<Destination>Bluetooth:AABBCC000000/</Destination>

</Message Type>http get</MessageType>

</MesssageBody/>

</Message>

WAP 220 may also be addressed by its IP address, or Internet name.

Information which may be requested from WAP 220 by mobile Device 280 may include but is not limited to:

Access Device Name

Network Name: Used to identify which network the access device provides access to. If a mobile device moves between two access points, if the network name associated with each access point is the same, the mobile device does not need to rediscover resources.

Location (of access point)

Location of Wireless Resource Server (URL)

IP Host or Domain Names which can be resolved.

Authentication URL

Communication Modes

Synchronous Requests (client server)

Asynchronous Requests (client server)

Asynchronous Requests (server client)

Synchronous Requests (server client)

Services: A list of services which WAP 220 provides. Examples of services may include: Web Access, Email, printing. Each service has the following information associated with it

Name

Attributes: used to identify service features/capabilities

Configuration URL: URL used to communicate configuration of services

The URL used to request this information may be, e.g. http://000000000000/, where 000000000 is the Bluetooth address of the WAP. Mobile device 280 may provide the following information to the WAP

Mobile Device Name

Location

Authentication Information

Communication Modes

Synchronous Requests (client server)

Asynchronous Requests (client server)

Asynchronous Requests (server client)

Synchronous Requests (server client)

Further still, in an exemplary embodiment, Request Interpreter 224 is responsible for converting the requests that come in via wireless interfaces 222, and creating the appropriate IP based request for the wired network.

In operation, a message is received from mobile device 280. If the request is for a WAP resource, execute the request. If the request is for a network resource, check the mobile device address. If the mobile device address is a MAC address, request Mobile ID from MDC 240 with MAC address. Substitute the source address with the Mobile ID. Process the request. If the mobile device address is a Mobile ID, verify the mobile ID with the MAC address through MDC 240 (this service could be locally cached to increase performance). If the mobile ID is verified, then process the request.

As an example, a request for a URL with an http protocol specified may be interpreted as a HTTP/TCP/IP request. When the response is received, the returned HTML or XML page is sent over the wireless link. Request Interpreter 224 may also receive messages to be sent to mobile device 280 asynchronously. The types of request which may be handled by the request interpreter may be extendable. HTTP processing is a required minimum, but functionality may be extended to handle mail, printing, and any other network based services.

In an exemplary embodiment, LAN access device 260 may be a standard wireless to wire network access bridge. This may represent a standard Bluetooth access point, or an 802.11 base station connected to an Ethernet network. These LAN access devices 260 may provide mobile device 280 with direct IP connectivity to the wired network. This device is shown to illustrate that mobile device 280 may connect through LAN access device 260 or use Wireless Access Proxy 220. The invention must support both cases, which requires that all services be directly accessible via IP or through Wireless Access Proxy 220.

Mobile resource server (MRS) 210 is a service which may be available to a wireless network. Its role is to provide a discoverable service which can inform wireless mobile devices 280 of resources available to them. When mobile device 280 connects to a network, it does not know what resources are available, or how to address them. While individual resources may be discovered by mobile device 280, it is desirable to have a more centralized repository of available resources to simplify the discovery process. Multiple mobile resource servers may exist on one network, although one would be optimal to reduce processing requirements on the client.

MRS 210 may be different from traditional Service Discovery servers for the following reasons:

1. MRS 210 may be specifically designed for mobile device service discovery because efficient transactions are advantageous.

2. MRS 210 may synchronously/asynchronously notify the mobile clients of resource status changes (resource becoming inactive, or new service becoming available).

3. The resources available to the mobile devices may be time and/or location dependent.

4. MSR 210 remembers the mobile resource state (it remembers which resources each mobile device currently thinks it has access to).

In an exemplary embodiment, MRS 210 may be queried for all resources available, resources matching specified attributes and./or keywords, and/or resource changes.

A mobile resource server may be discovered through multiple mechanisms, including but not limited to the following:

1. It may be registered with a Bluetooth Service Discovery server.

2. It may be registered with any network service discovery servers such as JINI.

3. It may be detected through an IP broadcast on the local LAN to a predetermined port (not yet assigned).

This is optional, such that simple web servers may serve as information servers. Further, the following information may be stored in the mobile resource server:

1. URL of available resources

2. URL of other information servers

3. URL of proxies and gateways

4. Location information

A URL may be used as a means of specifying the location of a network resource, although any other address/location scheme may also be used.

In an exemplary embodiment, each entry in the mobile resource server 210 may contain the following information:

Resource Name: A name associated with the resource.

URL: the URL for the resource

Status: the state of the resource

Active: the resource is available

Inactive: the resource is unavailable

Description: a text based description of the resource

Type: Identifies the type of the resource. Type could be one of the following (but not limited to)

Web Page/Server

Printer

Messaging

Email

Navigation

Access Restrictions: Information detailing which devices/user have access

Keywords: keywords describing the resource

Attributes: specific attributes of the resource

Information may be encoded in XML, and use appropriate standards where available. When the resource information is made available to a mobile device, an additional Accessibility field may be added to indicate whether the resource is accessible to the user/mobile device. The accessibility information may not be made available. An example encoding may look like:

<Resources>

<Resource>

<URL> http://wirelessweb.server.palm.com/</URL>
<Name> Palm WebServer </Name>
<Status > Active </Status>
<Access> Inaccessible </Access>
<Description> Palm Web Services Home

Page </Description>

<Type> WebServer </Type>
<Keyword> Palm </Keyword> <Keyword> Default
</Keyword>

</Resource>
< Resource>
.......
</Resource>

</Resource>

In an exemplary embodiment, the standard access protocol for the information server may be http. Optionally other protocols and/or access methods may be used including:

1. Java RMI (if server is written in java)

2. Raw Bluetooth (L2CAP, or L2CAP based protocol)

3. OBEX (over Bluetooth).

Other optional features for mobile resource server 210 include:

1 . Automatic detection of Service Discovery servers, and self registration of itself. The mobile resource server may be discovered in many ways, but it may be desirable to make the discovery process as quick as possible. This can usually be achieved through the use of service discovery in the wireless technologies. For example MRS 210 may register itself with a Bluetooth service discovery server.

2. Automatic detection of other MRS, and exchange of information. Multiple MRS may be used to increase reliability, through providing a backup MRS. Alternatively a network may contain multiple administrators that have control over different resources. By allowing other MRS to register themselves with each other, may make easier management of the MRS, and provide quicker resource discovery.

In an exemplary embodiment, the information server may be implemented as a simple web server, with XML pages containing information. In an exemplary embodiment, mobile Device Coordinator 240 may be responsible for:

Maintaining a list of mobile devices 280 in the network

Maintaining information about mobile devices 280

Communicating changes in mobile devices 280 with external systems

Providing proxy requests to mobile devices

Translating mobile ID into access point/MAC addresses

Applying user specified filters/preferences.

Storing user/mobile device specified preferences.

Removing mobile IDs after a period of inactivity because mobile IDs are not explicitly created or deleted

In an exemplary embodiment, the following attributes are associated with each mobile device:

Name

Current location

Location History

Capabilities

Network Gateway/Interface: specific addressing information to contact the mobile device

May be multiple entries is multiply connected

Access Restriction/Privileges

User specified preferences and filters

If a message is sent to the following URL, for example, http://mdc.wireless.palm.com/mobiledeviceID. The mobile address may also be of the form, http://mobileID.mdc.wireless.palm.com, for example. Or of the form: http://mobileID.wireless.palm.com. This form is more difficult to configure into servers as it requires coordination with DNS services. It does provide an ID independent of MDC 240, which is desirable for fault tolerance issues. The message will be received by MDC 240, and the following processing will occur:

The message may be applied to filters associated with the mobile ID

The message could be discarded, changed, or unchanged.

The address may be translated to a message for the mobile device

If multiple access point are available, one may be selected.

The message may be encapsulated in the message for the access point of the mobile device

The encapsulated message may be sent to the access point

In an exemplary embodiment, mobile resource proxy 230 may be responsible for proxying service requests. MRP 230 may be part of a firewall. Each request is analyzed according to

Mobile device ID

Requested Resource

The proxy service may carry out the following:

1. Identify the mobile device with the current request

a. the mobile ID may be encoded in request if the request can from a WAP

b. mobile ID encoded in request is ignored if the request comes from a LAN access device.

i. MDC is queried for mobile ID

c. MSR is queried to determine if access is allowed

i. Request includes mobile ID, resource

2. If the request is approved by MSR, the requested URL is obtained

3. If the request is not approved, the MRP may do one of the following

a. Return an authentication request

i. Could be a user ID/password web page

b. Return an error request

i. A web page with error message

The MSR may also be allowed to

Modify web pages (add ads, messages)

Replace web pages (login web pages, ads, local messages, alarms messages)

Exemplary methods utilizing system 200 are described below in accordance with various aspects of the invention, as embodied in the claims. The Examples are not to be viewed as limiting the scope of the invention but rather expanding the reader's understanding.

### EXAMPLE 1

A mobile device 280 enters a Bluetooth wireless network and requests a web page.

1. Mobile Device with Bluetooth enters coverage area

2. Bluetooth L2CAP link is established with WAP 220

3. Mobile device 280 requests a web page from WAP 220

a. WAP 220 reports connection to Mobile Device Coordinator 240

b. Mobile ID assigned

4. WAP 220 interprets request

a. Request send to Mobile Resource Proxy 230

5. Mobile Resource Proxy 230 receives request

a. Request verified with security server 250

6. Security Server 250 receives permission request

a. Mobile ID, Web Page

b. Request granted

7. Proxy 230 fetches web page, returns page to WAP 220

8. WAP 220 sends Page to mobile device 280

### EXAMPLE 2

Mobile device 280 enters 802.11 wireless network and requests a web page.

1. Mobile Device 280 with 802.11 enters coverage area

2. IP link established to 802.11 LAN access point 260

a. DHCP server is request to assign new IP address

i. Gateways, netsmasks, and other parameters also configured

b. DHCP server notifies MDC of new device

c. DHCP server assign IP address, address sent to access point

3. Mobile device 280 uses Service Discovery to find Mobile Resource Server 210

4. Mobile Device requests WEB proxy location

5. MRS 210 returns web proxy address/ configuration info

6. Mobile device 280 requests a web page via IP through LAN access point 250 to Mobile Resource Proxy 230

7. Mobile Resource Proxy 230 receives request

a. Request verified with MRS 210

8. MRS 210 receives permission request

a. IP address, Web Page

b. Request granted

9. MRP 230 fetches web page, returns page to mobile device 280.

a. Case 2: (alternative)

### EXAMPLE 3

Mobile device 280 enters 802.11 wireless network and requests a web page.

1. Mobile Device 280 with 802.11 enters coverage area

2. IP link established to 802.11 LAN access point 260

a. DHCP server is request to assign new IP address

i. Gateways, netsmasks, and other parameters also configured

b. DHCP server notifies MDC 240 of new device

c. DHCP server assign IP address, address sent to access point 260

3. Mobile device 280 sends http request to destination via network gateway

4. Firewall at network gateway, intercepts requests and sends it to MRP 230

5. Mobile Resource Proxy 230 receives request

a. Request verified with MRS 210

6. MRS 210 receives permission request

a. IP address, Web Page

b. Request granted

7. MRP 230 fetches web page, returns page to mobile device 280.

### EXAMPLE 4

Mobile device 280 enters Bluetooth wireless network and requests web page (secure document).

1. Mobile Device 280 with Bluetooth enters coverage area

2. Bluetooth L2CAP link established with WAP 220

3. Mobile device 280 requests a web page from WAP 220

a. WAP 220 reports connection to Mobile Device Coordinator 230

b. Mobile ID assigned

4. WAP 210 interprets request

a. Request send to Mobile Resource Proxy 230

5. Mobile Resource Proxy 230 receives request

a. Request rejected with MRS 210

6. Authorization form returned to mobile user (or authorization instructions)

a. Original request URL encoded in hidden fields

7. Mobile user enters user ID/password in authorization form

8. Mobile device sends authorization form to WAP 220

9. WAP 220 sends form to MRS 210

a. User ID/password verified

b. Original request forwarded to MRP 230

10. MRP 230 verifies request

a. Request granted

11. Proxy fetches web page, returns page to WAP 220

12. WAP 220 sends Page to mobile device 280

In an alternative process, a user could directly authenticate themselves first with MRS 210.

### EXAMPLE 5

A mobile device 280 retrieves location dependent information.

1. Mobile device 280 sends message to Navigation Service

a. Navigation service is already registered with WAP/RI

2. WAP 220 receives message

3. WAP 220 sends message to Navigation service

4. Navigation Service receives message

a. Extracts mobile ID

b. Requests mobile device location from MDC 220

5. MDC 220 receives location request

a. Returns currently location

6. Navigation application receives location info

a. Looks up map in database

b. Adds current position marker

c. Return map

7. Navigation application returns map to mobile device 280

### EXAMPLE 6

Mobile device 280 receives an asynchronous message.

1. Mobile device 280 sends registration message to Chat service

a. Mobile ID is registered

2. When a message needs to send to mobile device

a. Message is send to MDC 240

b. MDC 240 locates mobile device 280

c. MDC 240 sends message to access point/proxy

3. Access points sends message to mobile device 280.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A network infrastructure for supporting communications with mobile devices, comprising:
a communications network;
a mobile resources server coupled to the communications network;
a mobile resources proxy coupled to the communications network;
a mobile device coordinator coupled to the communications network;
a security server coupled to the communications network; and
a mobile device access point coupled to the communications network and configured for communications with mobile devices.

2. The network infrastructure of claim 1, wherein the mobile resources server, mobile resources proxy, mobile device coordinator, and security server are all server functions provided by a single server computer.

3. The network infrastructure of claim 1, wherein more than one of the mobile resources server, mobile resources proxy, mobile device coordinator, and security server are server functions provided by a single server computer.

4. The network infrastructure of claim 1, wherein the communications network is a local area network (LAN).

5. The network infrastructure of claim 1, wherein the communications network is a shopping area communications network.

6. The network infrastructure of claim 1, further comprising:
a wireless access proxy configured to send and receive non internet protocol (IP) communications.

7. The network infrastructure of claim 6, wherein the mobile device access point is configured to send and receive internet protocol (IP) communications.

8. The network infrastructure of claim 6, wherein the wireless access proxy includes a wireless network interface.

9. The network infrastructure of claim 8, wherein the wireless access proxy includes a request interpreter.

10. The network infrastructure of claim 9, wherein the wireless access proxy includes an IP network interface.

11. A communications system for communicating with mobile wireless devices, comprising:
a communications network;
a wireless device access point coupled to the communications network;
at least one mobile wireless device configured to communicate with the wireless access point when the mobile wireless device is within a communications range; and
a centralized management system configured to manage and control mobile device resources.

12. The communications network of claim 11, wherein the centralized management system includes a mobile resources server, a mobile resources proxy, a mobile device coordinator, and a security server.

13. The communications network of claim 11, wherein the centralized management system includes more than one of a mobile resources server, a mobile resources proxy, a mobile device coordinator, and a security server.

14. The communications network of claim 11, wherein the communications network is a local area network (LAN).

15. The communications network of claim 11, wherein the communications network is a shopping area communications network.

16. The communications network of claim 11, further comprising:
a wireless access proxy configured to send and receive non internet protocol (IP) communications.

17. The communications network of claim 16, wherein the mobile device access point is configured to send and receive internet protocol (IP) communications.

18. The communications network of claim 16, wherein the wireless access proxy includes a wireless network interface.

19. The network infrastructure of claim 18, wherein the wireless access proxy includes a request interpreter.

20. The network infrastructure of claim 19, wherein the wireless access proxy includes an IP network interface.

21. A method of providing a web page to a mobile device using a Bluetooth wireless transceiver, comprising:
establishing a wireless communications link with the mobile device;
receiving a web page request from the mobile device;
interpreting the request;
sending the request to a mobile resources proxy that verifies the request with a security server and after verification retrieves the web page;
receiving the web page from the mobile resources proxy; and
sending the web page to the mobile device.

22. A method of providing a web page to a mobile device using an IEEE 802.11 wireless transceiver, comprising:
establishing a wireless communications link with a local area network (LAN) access point;
locating a mobile resources server;
requesting a web proxy location;
receiving web proxy location;
requesting the web page through LAN access point and through mobile resource proxy; and
receiving the web page from the mobile resources proxy.

23. A method of retrieving a web page by a mobile device using an IEEE 802.11 wireless transceiver, comprising:
establishing a wireless communications link with a local area network (LAN) access point;
requesting a web page via a network gateway;
intercepting the request by a firewall;
sending the request by the firewall to a mobile resources proxy.
verifying request by the mobile resources proxy using a mobile resources server;
receiving the web page through the mobile resources proxy.

24. A method of providing a secure document to a mobile device using a Bluetooth transceiver, comprising:
establishing a wireless communications link with the mobile device;
receiving a web page request from the mobile device;
interpreting the request;
sending the request to a mobile resources proxy;
providing an authorization for to the mobile device;
receiving authorization information from the mobile device;
sending the authorization information to a mobile resources server that verifies the authorization information;
receiving the web page from the mobile resources proxy; and
sending the web page to the mobile device.

25. A method of providing location information to a mobile device, comprising:
receiving a location request from the mobile device;
sending the request to a navigation service that requests the mobile device location from a mobile device coordinator and receives a current location from the mobile device coordinator;
receiving a map from the navigation service, the map being developed by the navigation service based on the current location;
sending the map to the mobile device.

26. A method of providing a messaging service for a mobile device, comprising:
receiving a registration message to a chat service;
determining if a message is to be sent to the mobile device;
locating the mobile device;
sending the message to an access point that is in communications with the mobile device, the access point sending the message to the mobile device.
